(19) United States
(12) Patent Application Publication
(10) Pub. No.: US 2025/0138979 A1
(43) Pub. Date: May 1, 2025

(54) TECHNIQUES FOR DETERMINING AND MONITORING TRACKER GENERATOR PERFORMANCE

(71) Applicant: GONG.io Ltd., Ramat Gan (IL)

(72) Inventors: Inbal HOREV, Raanana (IL); Omri ALLOUCHE, Tel Aviv (IL); Raz NUSSBAUM, Tel Aviv (IL); Gil SAGI, Tel Aviv (IL); Yaniv LEVI, Tel Aviv (IL); Liran MERY, Tel Aviv (IL)

(73) Assignee: GONG.io Ltd., Ramat Gan (IL)

(21) Appl. No.: 19/005,455

(22) Filed: Dec. 30, 2024

Related U.S. Application Data
(63) Continuation-in-part of application No. 17/649,453, filed on Jan. 31, 2022.

(51) Int. Cl. G06F 11/34; G06F 16/31; G06F 16/334

(52) U.S. Cl. CPC G06F 11/3447; G06F 16/328; G06F 16/3347

(57) ABSTRACT

A method and system for monitoring a performance of a tracker model is presented. The method includes validating a tracker model using a testing set that includes a plurality of labeled textual data, wherein validating generates a trained tracker model and at least one set of performance metrics; generating a combined performance metric by aggregating the at least one set of performance metrics; and causing generation of a notification, wherein the notification includes the generated combined performance metric.

### CROSS-REFERENCE TO RELATED APPLICATIONS

This application is a continuation-in-part (CIP) of U.S. patent application Ser. No. 17/649,453, filed on Jan. 31, 2022, now pending, the contents of which are hereby incorporated by reference.

### TECHNICAL FIELD

The present disclosure generally relates to processing textual data, more specifically to techniques for monitoring the performance of labeling and tracking concepts in textual data.

### BACKGROUND

In sales organizations, especially these days, meetings are conducted via teleconference or videoconference calls. Further, emails are the primary communication means for exchanging letter offers, follow-ups, and so on. In many organizations, sales calls are recorded and available for subsequent review. The transcribed calls and emails from a corpus of textual data. Due to the volume of records in such corpus, reviewing the records to derive insight is time-consuming, and most of the information cannot be exploited.

Insights from analyzing sales calls or other sales records can be derived and may include identification of keywords or phrases that appear in conversations saved in the textual corpus. Identification of keywords may flag meaningful conversations to follow-up on or provide further processing and analysis. For example, identifying the phrase “expensive” may be utilized to improve the sales process.

A few solutions are discussed, in the related art, to identify keywords or phrases in textual data. Such solutions are primarily based on textual searches or natural language processing (NLP) techniques. However, such solutions suffer a few limitations, including, but not limited to, the accuracy of identification of keywords and identification of keywords having a certain context. The accuracy of such identification is limited as a search is performed based on keywords taken from a predefined dictatory. As such transcription may not be accurate (e.g., background noise), the identification may not be complete if only a keyword search is applied.

Further, even if the transcription is clear and without errors, identification of keywords without understanding the context may result in incomplete identification of similar keywords or identification of irrelevant keywords. For example, in a sales conversation the word “expensive” may be mentioned during a small talk as “I had an expensive dinner last night” or in the context of the conversation “your product is too expensive.” In a keyword search, searching “expensive”, both sentences may be detected, but only one of them can be utilized to derive insights with respect to an organization trying to sell a product. Further, the word “expensive” may be mentioned in the conversation in a different context, such as “I cannot afford this product.” Again, such sentences would not be detected by conventional solutions applying keyword searches.

Moreover, the validity of conventional solutions is even more challenging to track and monitor. Often times, such identification techniques are applied and utilized blindly without knowledge and confidence in the outputs they produce. The accuracy and relevance of such techniques still remain unknown. To this end, much time and resources can be wasted through inaccurate results, and repeated operations in order to improve the results.

It would therefore be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for monitoring performance of a tracker model. The method comprises: validating a tracker model using a testing set that includes a plurality of labeled textual data, wherein validating generates a trained tracker model and at least one set of performance metrics; generating a combined performance metric by aggregating the at least one set of performance metrics; and causing generation of a notification, wherein the notification includes the generated combined performance metric.

Certain embodiments disclosed herein also include a non-transitory computer readable medium having stored thereon causing a processing circuitry to execute a process, the process comprising: validating a tracker model using a testing set that includes a plurality of labeled textual data, wherein validating generates a trained tracker model and at least one set of performance metrics; generating a combined performance metric by aggregating the at least one set of performance metrics; and causing generation of a notification, wherein the notification includes the generated combined performance metric.

Certain embodiments disclosed herein also include a system for monitoring performance of a tracker model. The system comprises: a processing circuitry; and a memory, the memory containing instructions that, when executed by the processing circuitry, configure the system to: validate a tracker model using a testing set that includes a plurality of labeled textual data, wherein validating generates a trained tracker model and at least one set of performance metrics; generate a combined performance metric by aggregating the at least one set of performance metrics; and cause generation of a notification, wherein the notification includes the generated combined performance metric.

Certain embodiments disclosed herein include the method, non-transitory computer readable medium, or system noted above, further including or being configured to perform the following steps: receiving feedback on the trained tracker model based on the combined performance metric.

Certain embodiments disclosed herein include the method, non-transitory computer readable medium, or system noted above, further include or being configured to perform the following steps: determining, based on the combined performance metric, that the trained tracker model training is complete; and activating the trained tracker model for an identification of future textual data.

Certain embodiments disclosed herein include the method, non-transitory computer readable medium, or system noted above, further including or being configured to perform the following steps: determining, based on the combined performance metric, that the trained tracker model training is incomplete; generating a new testing set that has a plurality of new labeled textual data; and repeating the validating, generating, and causing.

Certain embodiments disclosed herein include the method, non-transitory computer readable medium, or system noted above, wherein the feedback has a threshold setting of the trained tracker model, wherein the threshold setting is identified from the combined performance metric of the trained tracker model, and further configured to: tune the trained tracker model according to the threshold setting.

Certain embodiments disclosed herein include the method, non-transitory computer readable medium, or system noted above, further including or being configured to perform the following steps: dividing the plurality of labeled textual data of the testing set into substantially equal-sized groups; training the tracker model with a first subset to obtain a first trained tracker model; wherein the first subset is a portion of the plurality of labeled textual data apart from a first equal-sized group; applying the first trained tracker model to textual data of the first equal-sized group in order to label tracker-relevant labels for the textual data of the first equal-sized group; and determining the set of performance metrics based on the labeled textual data of the first equal-sized group.

Certain embodiments disclosed herein include the method, non-transitory computer readable medium, or system noted above, further including or being configured to perform the following steps: successive repeating the validation of the tracker model using all of the substantially equal-sized groups.

Certain embodiments disclosed herein include the method, non-transitory computer readable medium, or system noted above, wherein the set of performance metrics and the combined performance metric include any one of: an accuracy, a precision, a recall, and a precision-recall curve.

Certain embodiments disclosed herein include the method, non-transitory computer readable medium, or system noted above, wherein the trained tracker model is configured to identify a unique concept in textual data, wherein the textual data is derived from at least one of: email, text message, and call.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a framework illustrating the generation and application of a tracker model used for classifying and identifying one or more trackers in textual data according to an embodiment.

FIG. 3 is a diagram of index of vectors representing sentences generated according to an embodiment.

FIG. 4 is a flowchart illustrating the generation of the tracker model according to an embodiment.

FIG. 5 is a flowchart illustrating a method for generating an index of vectors representing sentences according to an embodiment.

FIG. 6 is a flowchart illustrating a method for monitoring a performance of a tracker model according to an embodiment.

FIG. 7 is a flowchart illustrating a method for training and testing a tracker model according to an embodiment.

FIG. 8 is a schematic diagram of a tracker generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for monitoring performances of a tracker model according to an embodiment. The tracker model is trained and generated to identify, label, and track concepts in textual data including, for example, but not limited to, transcripts of calls, emails, messages, chat logs, and the like, and any combination thereof. The performance of the tracker model is determined by testing labeled sample sentences on the trained tracker model. According to the disclosed embodiments, the performances may be determined prior to applying the tracker model for inference through validation using training and testing with the labeled sample sentences. A combined performance metric is generated of the trained tracker model to provide the performances and training status against textual data. The performances are represented as performance metrics such as, but not limited to, accuracy, precision, recall (hit rate), precision-recall (PR) curve, and the like, and any combination thereof. The embodiments disclosed herein enable performance monitoring using a relatively smaller set of labeled sentences (textual data).

A tracker, as defined herein, is a keyword or phrase with a specific context. A tracker provides a general concept of a word or phrase. For example, a tracker may be a “pricing objective.” The pricing objective may encompass keywords, such as “expensive,” “high-priced,” “overpriced,” “overrated,” or phrases, such as “it is too expensive,” “I can't afford that,” and so on. In an example embodiment, the identification of trackers in the textual data is performed using a machine learning classification model (hereinafter a “tracker model”). The tracker model is trained based on a small subset of labeled samples, thereby generating the classification model quickly while conserving computation resources.

The tracker model is trained to identify trackers in the textual data. That is, words or phrases with similar meanings will be classified or identified as a tracker. However, words mentioned in a different context will not. For example, the sentence “the feature is overrated” and “the product is expensive” would be classified as the same tracker (e.g., a pricing objective). Whereas the “this restaurant is overrated” and “the product is expensive” would be classified as different trackers. Thus, the disclosed embodiments improve the accuracy of keyword identification in textual data when the correct context is critical to generating meaningful insights.

It has been identified that the performance of the classification model is challenging to determine and often requires a large amount of manual tagging of textual data which is obtained through extended time and label. The embodiments disclosed herein utilize a validation method and their combinations based on a relatively smaller set of labeled textual data (sentences). Such performances are automatically and immediately determined from a learning set without extensive computing or manual labeling. In the disclosed embodiments, the performances may be determined with training, prior to deployment, thereby providing visibility and predictions on the classification capabilities of the tracker model.

The disclosed embodiments also provide a quantitative visibility of the performance and training status of the tracker model. The quantitative analysis enables objective decisions on whether the training of the tracker model is complete. It should be noted that such performance analysis provides an accurate estimate of performance based on the limited amount of textual data for a concept that is specific to an organization. Often in current technology, users may not have the ability to gain performance insights or control over machine learning training statuses and thus, may be blindly deploying and using such models. However, the embodiments disclosed herein provide the user with a clear quantitative analysis of the training status and expected performance when deployed in a live setting for new textual data. It should be noted that such performance monitoring avoids indiscreetly applying the tracker model in order to conserve computing resources.

Moreover, a precision-recall (PR) curve may be utilized for customized tuning of the tracker model. The precision-recall curve shows the relationship between the precision and recall values, often inversely related, for the tracker model that is trained using the learning set. The tracker model may be tuned or customized according to the need of a user employing the tracker model for identifying textual data. In some cases, a configuration with optimized precision and recall performances may be detected and selected for generating an optimized tracker model. The configuration of the tracker model may be readily and rapidly tuned and output.

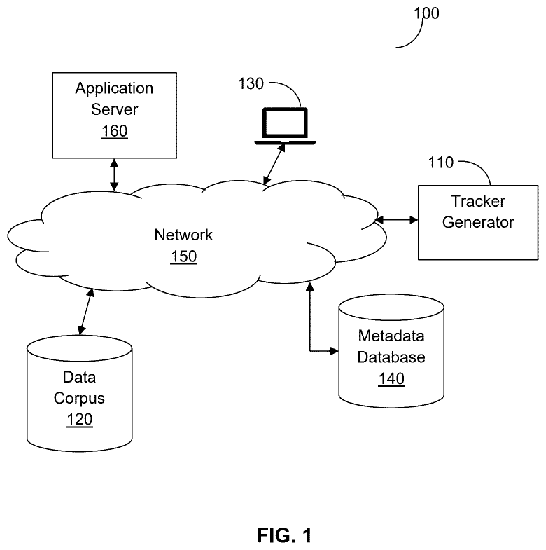

FIG. 1 shows an example network diagram 100 utilized to describe the various disclosed embodiments. In the example network diagram 100, a tracker generator 110, a data corpus 120, a user terminal 130, a metadata database 140 connected to a network 150. In one configuration, an application server 160 is also connected to network 150. The network 150 may be but is not limited to, a wireless, a cellular, or wired network, a local area network (LAN), a wide area network (WAN), a metro area network (MAN), the Internet, the world wide web (WWW), similar networks, and any combination thereof.

The data corpus (or simply “corpus”) 120 includes textual data from transcripts, recorded calls or conversations, email messages, and other types of textual documents. It should be appreciated that the transcripts often include errors due to noises in the recordings or other effects affecting the voice-to-text recognition. In the example embodiment, the textual data in the corpus 120 includes sales records. The data corpus 120 may further include the trackers generated by the tracker generator 110.

The metadata database 140 may include metadata on calls transcribed or other data stored in the corpus 120. In an embodiment, metadata may include information retrieved from customer relationship management (CRM) systems or other systems that are utilized for keeping and monitoring deals. Examples of such information include participants in the call, a stage of a deal, a date stage, and so on. The metadata may be used in the training processing of the tracker model.

The user terminal 130 allows a user, during a training phase, to enter phrases or keywords of interest, confirm labeling, or label certain sentences, to train the tracker model. Once the tracker model is ready, the user through the user terminal 130 can query the tracker model to identify the trackers in the data corpus 120. Such queries can be processed by the application server 160. The application server 160, in some configurations, can process or otherwise analyze the textual data in the corpus 120 based on the identified trackers. For example, the application server 160 can execute applications to flag all conversations identified with a pricing objective tracker.

According to the disclosed embodiments, the tracker generator 110 is configured to create tracker models. The tracker model can be generated per tracker. The tracker generator 110 can classify or otherwise identify tracker(s) in the textual data stored in the corpus 120. This may be performed in response to an application executed by the application server 160. The operation of tracker generator 110 for generating (and training) models is discussed in greater detail below.

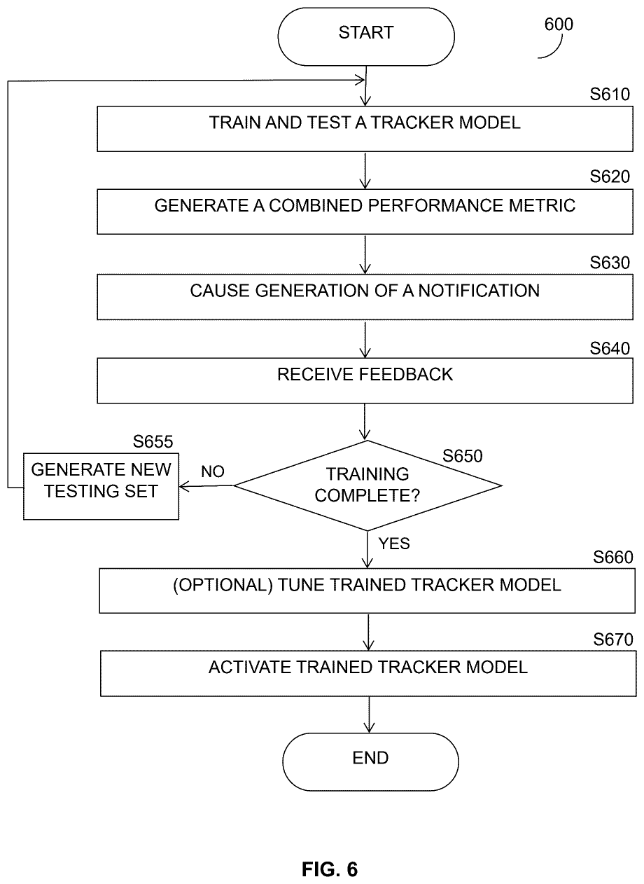

The tracker generator 110 may be realized as a physical machine (an example of which is provided in FIG. 6), a virtual machine (or other software entity) executed over a physical machine, and the like.

It should be noted that the elements and their arrangement shown in FIG. 1 are shown merely for the sake of simplicity. Other arrangements and/or a number of elements should be considered without departing from the scope of the disclosed embodiments. For example, the tracker generator 110, the data corpus 120, and the application server 160 may be part of one or more data centers, server frames, or a cloud computing platform. The cloud computing platform may be a private cloud, a public cloud, a hybrid cloud, or any combination thereof.

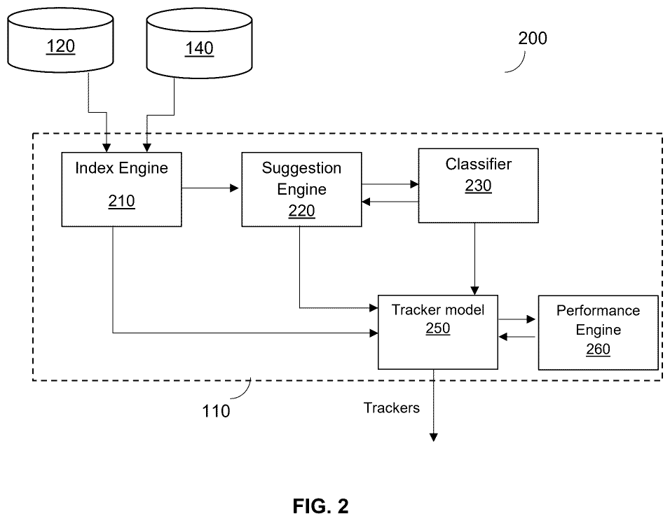

FIG. 2 is an example framework 200 illustrating the generation and application of a tracker model 201 used to classify and identify one or more trackers in textual data according to an embodiment. For simplicity and without limitation of the disclosed embodiments, FIG. 2 will also be discussed with reference to the elements shown in FIG. 1.

The framework 200 operates in two phases: learning and identification. In the learning phase, a tracker model 201 is generated and trained, in the identification phase, the trained model 250 is utilized for the identification of one or more trackers in transcripts of conversations or other textual data saved in the corpus 120.

As illustrated in FIG. 2, the framework 200 includes an index engine 210, a suggestion engine 220, a classifier 230 configured to output the tracker model 250, and a performance engine 260. Here, the classifier 230 is a supervised machine learning used by machines (e.g., GPUs) to classify data. The tracker model 250 is an output of the classifier's 230 machine learning algorithm. The tracker model 250 is trained using the classifier 230's machine learning algorithm, so that the model, ultimately, classifies textual data to identify trackers. It should be noted that the engines are logical components of the tracker generator 110 and the framework 200 shows an example configuration for illustration purposes and does not limit the scope of the disclosed embodiments. Some components may be combined, separated, or both without departing the scope of the disclosed embodiments.

In an embodiment, the tracker model 250 is a supersized machine learning model that can be utilized to identify tracker(s) in transcribed conversations. In an example embodiment, the tracker model 250, once trained allows classification of future conversations. The tracker model 250 is trained per tracker (e.g., a pricing objective, etc.) representing a unique concept.

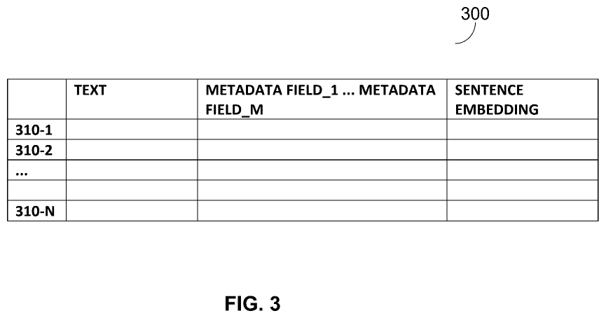

The index engine 210 is connected to the data corpus 120 and metadata database 140. The index engine 210 is configured to process data in the corpus 120 to output an index of transcribed calls (or other textual data). An example of index 300 is shown in FIG. 3. The index 300 includes a plurality of entries 310-1 through 310-N. Each entry 310 represents a vector for a sentence and includes a sentence (text), one or more metadata fields, and a vector representation (embedding value) of the sentence. The metadata is retrieved from the metadata database 140 and may include a specific time in the conversation that the sentence was said, participants in the calls, their locations, the stage in the deal, the topic of any other information from a CRM system associated with the call, or information associated with the call.

As an example, the data an entry 310 may include the following:

```
Sentence (text): “If we buy 100 licenses, do we get a discount?”
Metadata Fields:
  Deal type: New Business
  Deal stage: Negotiation
  Tier: SMB
  Topic: Pricing
  Time in call: 00:36:24 / 00:56:00
  Affiliation: Company
Word Embedding: [−2.10331809e−02, −2.06176583e−02,
6.59231246e−02
... 8.64016078e−03, −7.70692620e−03, 6.42301515e−02]
```

In an embodiment, the index engine 210 is configured to first split the textual data in the corpus into sentences. Each sentence is preprocessed to have a unified representation. In an example embodiment, the preprocessing includes removing disfluencies, normalizing dates and/or number notation, capitalizing names, and so on. For example, all dates can be converted into <yyyy,mm,dd> format. Clearing of disfluencies is performed on transcripts. The purpose of preprocessing sentences is to remove noise from the text being processed. It should be noted that entries 310 in the index 310 are not ordered in a specific order.

The index engine 210 is further configured to generate a vector representation (sentence embedding) for each sentence. The vector representation may be performed using sentence or word embedding techniques discussed in the related art. For example, sentence embedding is a representation of document vocabulary that allows capturing the context of a word in a document, semantic and syntactic similarity, relation with other words, and so on. Using sentence word embedding, words are represented as real-valued vectors in a predefined vector space. Each word is mapped to one vector, and the vector values are learned in a way that resembles, for example, a neural network. Sentence or word embedding techniques that can be utilized by the index engine 210 may include embeddings from language model (ELMo), bidirectional encoder representations from transformers (BERT), and the like.

To complete an entry, relevant metadata information to the respective sentence is obtained from the metadata database 140 and associated with the sentence and its vector representation. The suggestion engine 220 is configured to receive input queries from a user through the user terminal 130. Each such input query may include one or more sentences that express a potential tracker of interest. The user may also provide metadata fields for filtering certain conversations in the corpus 120. An example of an input query may be:

```
    Sentence (text): Can we do something to lower the price?
    Is there any
  flexibility in terms of pricing? Would it be possible to get
  a better quote?]
    Metadata Field:
      Tier: SMB
      Affiliation: Company
Where “tier” and “affiliation” are metadata fields.
```

The suggestion engine 220 is further configured, for each input query, to compute its vector representation. This may be performed using one of the sentence embedding techniques mentioned above. The suggestion engine 220 is configured to obtain from the index (e.g., 310) a set of vectors satisfying the vector representation of the input query. This is performed by requesting the index engine 210 to return all vectors substantially matching the input query's vector representation and potentially metadata fields provided by the user. The results returned by the index engine 210 are referred to hereinafter as a “base results set.”

In an embodiment, the sentences to be included in the base results set are determined based on a computed distance between each sentence (represented by its sentence embedding value) in the index and the input query's sentences (represented by its sentence embedding value). Specifically, the distance may be computed as an aggregate function (e.g., a mean function, a maximum function, etc.) over the distances between the respective sentence embedding values (of each entry in the index and an input query's sentence).

The suggestion engine 220 is further configured to compute and output a labeling set derived from the base results set. The labeling set includes a small number of sentences to be labeled. In an example embodiment, the number of sentences in a labeling set is less than 20. In contrast, the base results set includes hundreds of sentences. In an example embodiment, sentences in the labeling set are provided, for example, to the user to label the relevancy to the input query.

The sentences in the labeling set may be selected such that they are varied but still in the general scope of the input query's sentence. In an embodiment, the selection may be performed by clustering the sentence embedding values of respective sentences included in the base results set. The clustering is performed such that small, compact clusters are formed. Since close vectors have similar semantic meanings, such clusters presumably demonstrate synonymous meanings. In an embodiment, one sentence from each cluster is selected to be included in the labeling set. It should be noted that clusters that are distant enough from each other, but not too distant from the original input sentences are sampled for the creation of the labeling set.

Collectively or alternatively to the clustering technique, sentences in the labeling set may be selected based on a simplified machine learning model being trained on the spot as the user provides feedback on an initial set of sentences. Such a model can be programmed to infer candidate sentences from all sentences in the base results set. It should be noted that the suggestion engine 220 is configured to iteratively generate labeling sets until the tracker model 250 is trained.

According to the disclosed embodiments, sentences in a labeling set are presented to a user through, for example, the user terminal 130. The user is requested to label such sentences by indicating if each sentence is related, unrelated, or somehow related to the input query's sentence. In an example configuration, a graphical user interface (GUI) may be provided for the labeling request for the user to select an option, or provide a score (e.g., 1-5) based on relevance.

The labeled sentences are fed to the classifier 230 for the training of the tracker model 250. In addition, the classifier 230 is configured to score the sentences in the base results set. In an example embodiment, a higher score signifies a stronger affinity to a tracker of interest. This is performed to allow the selection of different sentences to be included in a subsequent labeling set. The selected subsequent sentences may be a mix of sentences with confidence of relevancy and some with uncertainty about the relevancy.

The training of the model (based on the labeling sets) continues until it is determined that the tracker model 250 is well-trained. This decision on when to stop the training may be taken by the user or after a predefined number of iterations is completed. In an example embodiment, the training of the model may continue with a subsequent labeling set to perform another training round.

According to the disclosed embodiments, the performance of the trained and output tracker model 250 is monitored using a subsequent set of labeled sentences, referred to hereinafter as a testing set, that is previously unseen by the tracker model 250. The testing set may be selected from, for example, the labeling set, the index, the corpus, or the like and include a sample sentence and associated tracker-relevant label for each sentence. In an example embodiment, the performance of the tracker model 250 is detected through cross-validation during the training of the tracker model 250. The performance engine 260 is configured to analyze outputs (i.e., labeled sentences based on tracker relevance) of the tracker model 250 with respect to the known labels of the testing set and to generate performance metrics such as, but not limited to, an accuracy, a precision, a recall, and the like, and any combination thereof. The performance metrics provide a quantitative evaluation and/or training status of the tracker model 250. In some implementations, the performance of the tracker model 250 is determined after training with at least a predefined threshold number of labeled sentences. As an example, the predefined threshold number is 100 and the performance metric is generated after completing training with at least 100 labeled sample sentences. It should be noted that the performance may be determined at any point thereafter.

The testing set includes a small number of sentences that are labeled according to their relevancy to the targeted tracker of the tracker model 250. One or more components of the tracker generator 110 such as, but not limited to, the index engine 210, the suggestion engine 220, the classifier 230, and the like, are utilized to generate the testing set. In an example embodiment, the testing set is selected from the index (e.g., 300, FIG. 3) of textual data such as, but not limited to, transcribed calls stored in the corpus 120. In another example embodiment, the testing set may be generated from the base results set as described above for the labeling set. In yet another example embodiment, the testing set is retrieved from the corpus (e.g., the data corpus). The sentences may be derived from existing textual data, new textual data, or both. It should be noted that raw sentences are input and processed for training and analysis within the tracker generator. In some example embodiments, without limitation, the raw sentences may be represented as vectors (sentence embedding values), using the embedding methods described above, for processing at the tracker generator.

Portions (or subsets) of the labeled sentences of the testing set are fed to the classifier's 230 machine learning algorithm to train and output a trained tracked model 250. For each subset round of training using one of the portions, the trained tracker model 250 is then tested using the remaining sentences of the testing set that were not fed into the classifier 230 and not utilized for the training. A group of the remaining sentences set aside during training and used for validating (or testing) the trained tracker model is herein referred to as a held-out group. The sentences in the group are fed to the trained tracker model 250 to classify the sentences with respect to relevance to the targeted tracker concept.

The subset round of training and testing may be performed for each of the groups. As an example, when a K number of substantially equal sized groups are generated, a K number of subset rounds may be performed. That is, the training using the testing set may continue until all groups are tested after their respective training subset round. In an example embodiment, the grouping and partitioning of the testing data for each subset round may be performed at a suggestion engine 220.

According to the disclosed embodiments, the performance engine 260 is configured to determine a combined performance metric for the tracker model 250 through statistical analyses of a plurality of performance metrics generated from the plurality of subset rounds of training and testing using different portions of the testing set. For example, the combined performance metrics are determined upon cross-verification with all groups that were partitions in the testing set. The combined performance metrics include, for example, but are not limited to, an accuracy, a precision, a recall, a precision-recall curve, and the like to indicate a performance and training status of the tracker model 250 upon training with the testing set. As an example, the combined accuracy of the testing set may include an average, a median, a maximum, a minimum, and the like, and any combination thereof determined from analyzing the accuracies determined at each subset round of the testing set.

In an embodiment, the performance of the tracker model 250 may be determined continuously, intermittently, regularly, on-demand, or the like. As an example, the performance of the tracker model 250 may be determined after completing a training round to track the training status, before the tracker model 250 is applied to new textual data. In another example, the performance is checked after employing the tracker model 250 for classifying textual data at the identification phase. It should be noted that the performance analysis is rapidly performed during the training of the tracker model without separate data and processing needed on the tracker model 250 thereafter. It should also be noted that the quantitative performance analysis at the learning phase enables monitoring the tracker models' training status, thereby improving the accuracy of the model as well as avoiding tracker identification using premature and/or inaccurate versions of the tracker model 250. One of ordinary skill in the art would understand that such visibility and tracking reduce the amount of data processing and thus conserve computing resources.

In an embodiment, a notification, including, without limitation, the performance metrics, is caused to be generated and presented to a user through, for example, the user terminal 130. The user may utilize the GUI to provide feedback, a decision, or the like by, for example, selecting an option, or providing a value, or the like, with respect to the notification. In an example embodiment, a specific classification threshold value for the tracker model may be determined and/or selected based on the user input. In an embodiment, the performance engine 260 is configured to implement the classification threshold value to generate a tuned tracker model 250.

In addition to the training, the tracker model 250 may be manipulated for the desired performance. As an example, the tracker model 250 may be tuned to classify for higher precision over recall. In an embodiment, the performance metric includes a precision-recall curve (PR) that represents a trade-off between a precision and recall values for the trained tracker model. The PR curve may be utilized by, for example, and without limitation, the tracker generator and/or the user of the user terminal, to determine a classification threshold setting (or value) for the trained tracker model. In a further embodiment, the feedback based on such performance metrics may be implemented to tune and customize the trained tracker model as needed or desired. It should be appreciated that the performance tracking enables clear visibility into the performance and training status of the tracker model, which further, may be directly and specifically utilized to improve and customize the tracker model for improved accuracy and efficiency.

In some example embodiments, the classifier 230 may be realized using a neural network, a deep neural network programmed to run a supervised machine learning. The supervised machine learning algorithms may include, for example, a k-nearest neighbors (KNN) model, a Gaussian mixture model (GMM), a random forest, manifold learning, decision trees, support vector machines (SVM), decision trees, label propagation, local outlier factor, isolation forest, and the like.

In an embodiment, the trained tracker model 250 is used to identify trackers in future transcripts (or other textual data) stored in the data corpus 120. Future textual data refers to any data stored after the model 250 is trained or data not used for the training of the trained tracker model 250. To this end, the processing of sentences fed into the trained tracker model 250 is performed by the index engine 210 as discussed above. That is, the trained tracker model 250 is operational in the identification phase of the framework 200. In some implementations, the tracker model 250 used in the identification phase may be a tuned tracker model 250 that is generated to identify trackers with a goal to meet desired performance metric values.

The trained tracker model 250 may be executed using the same neural network and the supervised machine learning as the classifier 230. Examples of supervised machine learning algorithms are provided above.

It should be noted that in some configurations, the index engine 210, the suggestion engine 220, the classifier 230, and the performance engine 260 are elements of the tracker generator 110. It should be further noted that the index engine 210, suggestion engine 220, classifier 230, and/or the performance engine 260 can be realized as or executed by one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

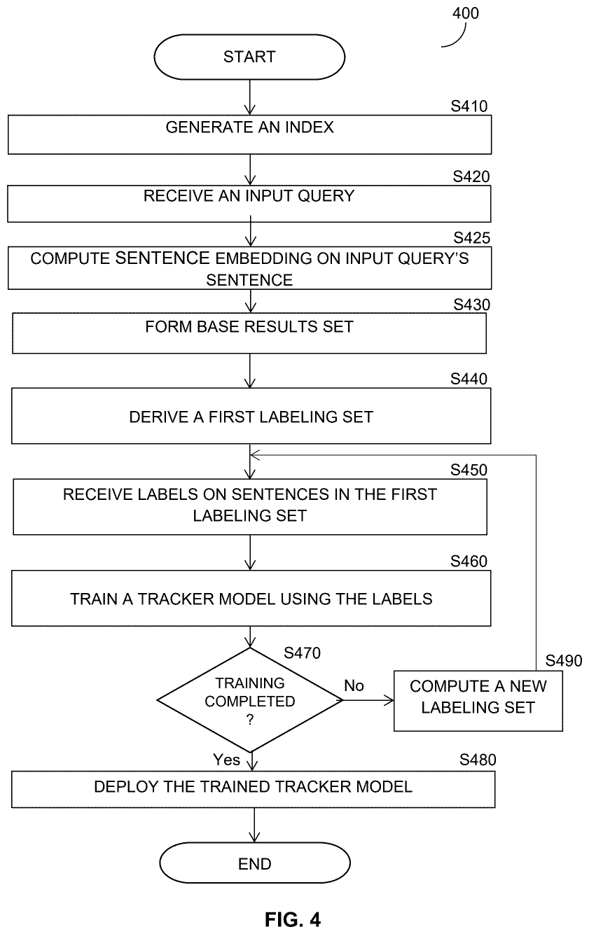

FIG. 4 is an example flowchart 400 illustrating the generation of the tracker model according to an embodiment. The tracker model allows the application of identifying keywords and phrases with the same context in textual data. The textual data may include text records, such as transcripts of sales calls, emails, text messages, and the like.

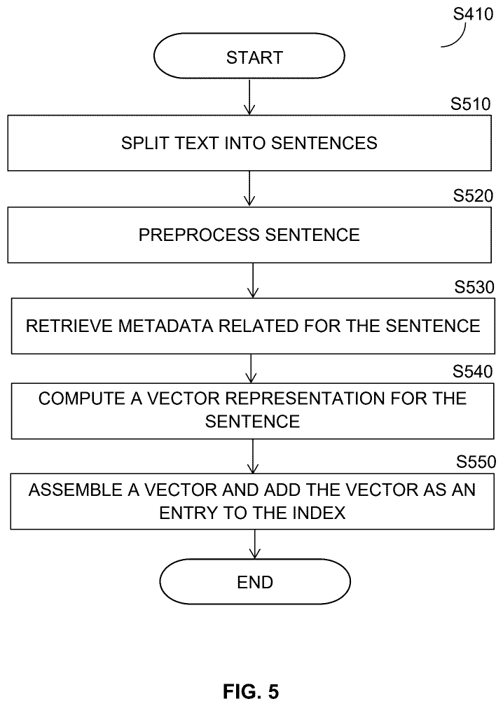

At S410, the text data saved, for example, in a corpus, is processed to generate an index. An index includes a plurality of entries, each entry represents a vector. As demonstrated in FIG. 3, an entry includes a sentence (text), metadata fields, and sentence embedding values of the text. An index is generated per tenant (customer) having stored data in the corpus. It should be noted S410 may be performed in the background and independent of the training of the model. The operation of S410 is further discussed with reference in FIG. 5. FIG. 5 is an example flowchart S410 illustrating a method of generating the index according to an embodiment.

At S510, the text is split into sentences. To this end, each call transcript or email is divided into sentences. Sentences may be detected in the text based on punctuation, moments of silence, speaker changes, and so on.

At S520, each sentence is preprocessed to clean noise. This includes removing disfluencies, normalizing dates and/or numbers notation, capitalizing names, and so on. At S530, metadata related to the sentence is retrieved from a database (e.g., the metadata database 140, FIG. 1). The metadata may include, for example, information from a CRM system having records related to the conversation (or email) that the sentence was taken from. Examples of metadata values and fields are provided above. At S540, a vector representation which is an embedding value, is computed over the sentence. At S550, a vector is assembled and added as an entry to the index. The vector, and hence the entry, includes, for example, the sentence, metadata fields, and an embedding value. It should be noted that S520 through S550 is performed for each sentence identified at S510.

Returning to FIG. 4, where at S420, an input query is received. The input query includes a sentence that exemplifies a tracker of interest. The tracker is defined as a concept and is not bound to certain dictionary words or phrases. Various combinations of words and phrases may be identified as the tracker of interest if the overall meaning and concept are aligned. At S425, a sentence embedding value of the input query's sentence is computed.

At S430, a base results set is formed. In an embodiment, this includes computing the distance between the sentence embedding value of the input query's sentence and each vector's embedding value in the index. The distance may be computed, for example, using an aggregated function. In an embodiment, each computed distance less than a predefined threshold is added to the base results set. For example, the input query's sentence is:

```
  “Can we do something to lower the price?”
    Word Embedding: [0.002]
The index includes the following vectors (saved in the index's entry):
(1) “this burger is too expensive.”
    Word Embedding: [0.7]
(2) “the product is great, but doesn't meet our budget.”
    Word Embedding: [0.003]
```

The distance between the input sentence, computed using a maximum function, to sentence (1) is 0.7, and the distance between the input sentence to sentence (2) is 0.003. Thus, sentence (2) is closer (minimum distance) to the input sentence and will be added to the base results set. In an embodiment, sentences to be included in the base results set may be determined using a K-nearest neighbors (KNN) algorithm.

At S440, a first labeling set is derived from the base results set. The number of sentences in a first labeling set is significantly less than the number of sentences (vectors) in the base results set. In an embodiment, the first labeling set is selected by clustering vectors in the base results set. For example, a hierarchical clustering algorithm is utilized to find clusters of similar vectors. A hierarchical clustering is an algorithm of cluster analysis that seeks to build a hierarchy of clusters. Strategies for hierarchical clustering may generally include an agglomerative approach where each observation starts in its own cluster, and pairs of clusters are merged as one moves up the hierarchy; a divisive approach where all observations start in one cluster, and splits are performed recursively as one moves down the hierarchy. In general, the merges and splits are determined in a greedy manner. The results of hierarchical clustering are usually presented in a dendrogram.

Then, from each cluster, a sample sentence is selected and added to the first labeling set. It should be noted that clusters determined to be far (i.e., the distance over a predefined threshold) are not considered for the labeling set. It should be further noted that a vector is an entry in the generated index (at S410) that includes all the data mentioned above.

At S450, a label input on each sentence included in the first labeling set is received. In an example embodiment, a user is prompted to provide the input label in the form of how relevant a sentence is to the tracker of interest. As an example, the sentences may be labeled as one of related, unrelated, or somehow relevant. In another example, the label may be a score (e.g., integer) between 1 and 5.

At S460, a tracker model is trained using the sentences associated with the input labels. The labeled sentences belong to the first labeling set that is derived from the base result set (S440). Further, the input labels are sent to a labeling model that can be utilized to generate a new labeling set.

At S470, it is checked if the tracker model is trained and ready for use in an identification mode. If so, execution continues with S480, where the trained tracker model is employed as a classifier configured to identify the tracker in future conversations (i.e., new textual data added to the corpus). For example, if the tracker is “pricing objective”, all calls that include the concept of “pricing objective” are identified. A list of such calls can be output and displayed to the user via a user terminal (e.g., the user terminal 130, FIG. 1). Otherwise, at S490, a new labeling set is computed, and execution is returned to the S450. The new labeling set may be computed using the labeling model, the hierarchical clustering algorithm, or both. These techniques are discussed in detail above.

FIG. 6 is an example flowchart 600 for monitoring a performance of a tracker model according to an embodiment. The method disclosed herein is performed at the tracker generator 110, FIG. 1 via components of the example framework 200, FIG. 2.

The tracker model is trained to identify keywords, phrases, sentences, or the like that are related to a concept of the tracker model from textual data. Thus, the performance is monitored with respect to the tracker model's effectiveness in such classification and identification. In some implementations, the performance of the tracker model is determined after completing a predefined number of training sentences. As an example, the predefined number is one hundred, and thus, the performance is monitored after training with at least one hundred sample-labeled sentences as part of the learning sets.

In an embodiment, the performance of the tracker model is monitored as the tracker model is trained with a learning set. The learning set employed for the performance monitoring is herein referred to as a testing set. The testing set includes a small number of sample sentences that are labeled by their relevance to the tracker of interest (i.e., concept) and may be generated from the textual data, existing or new, that are stored in the corpus, for example, as described above in FIG. 4. The performance of the tracker model provides quantitative training statuses that may be used to determine completeness of the training.

The performance monitoring of FIG. 6 is described to be performed during the learning phase. However, it should be noted that the scope of the disclosed embodiments is not limited thereto and the performance of the tracker model may be monitored at various stages or phases of the tracked model, for example, but not limited to, during training with one or more learning sets, before deployment of the trained model, after deployment of the trained model, or the like, and more.

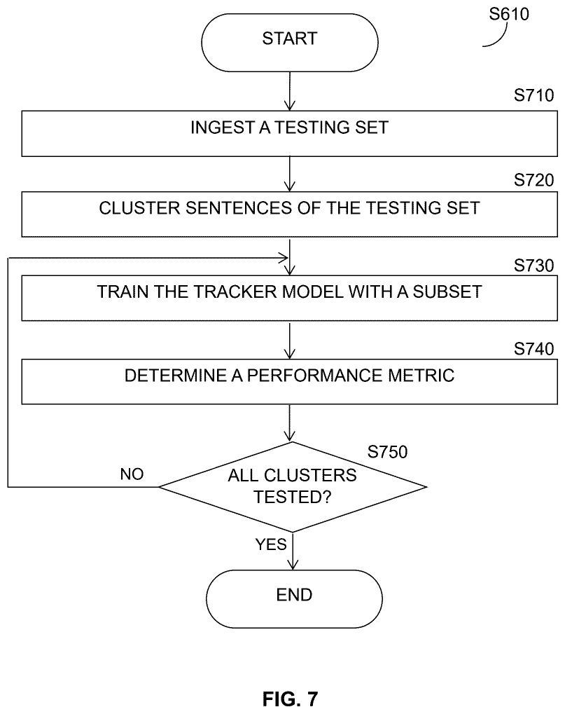

At S610, a tracker model is trained and tested (i.e., cross-validated) using a testing set. The testing set includes labeled sentences (raw textual data) that are yet unseen by the tracker model. In an embodiment, a plurality of performance metrics is generated from the cross-validation using the testing set. The performance metric includes, for example, but is not limited to, an accuracy, a precision, a recall, and the like and is determined for each subset round of training performed. That is, a trained tracker model and a plurality of performance metrics are output from the training and testing. The training and testing of the tracker model through cross-validation is described in further detail below in FIG. 7.

At S620, a combined performance metric is generated for the trained tracker model. The plurality of performance metrics is aggregated from the multiple subset rounds by their type, for example, precision, recall, and the like, and statistical analysis is applied to generate the combined performance metric. In an embodiment, the combined performance metric includes, for example, but is not limited to, average, median, maximum, minimum, and the like, statistical values for the type of metrics.

In a further embodiment, the combined performance metric includes a precision-recall (PR) curve that graphically represents the relationship, or trade-off, between the precision and recall values for the trained tracker model. The PR curve shows how the precision and recall change at different threshold settings of the tracker model. It should be noted that there are often trade-offs between precision and recall, where lowering a threshold may allow increased recall of true positive instances, but in return, reduce precision by classifying more false positives. On the contrary, increasing the threshold may increase precision, for fewer false positives, but in return decrease recall of true positives.

At S630, a notification is caused to be generated. The notification such as, but not limited to, a report, an alert, or the like, includes performance information of the trained tracker model. The performance information may be provided in various forms such as, but not limited to, numbers, percentages, colors, scales, degrees, and the like, and any combination thereof to represent the combined performance metric determined by the tracker model. As noted above, the performance metric may include a PR curve of the trained tracker model, which is added to the notification. The notification may be presented to a user via, for example, a user terminal (e.g., the user terminal 130, FIG. 1). In an example embodiment, the notification may be generated and presented as part of a graphical user interface (GUI) for users to interact and input selections in response to the presented notification.

In an example embodiment, the notification may include sample sentences that are classified as being relevant by the trained tracker model. The sample sentence is a natural human language representation of the sentence (vector embedding) that is identified as a related sentence from the current training status of the tracker model. In a further example embodiment, the notification may include suggestions with respect to, for example, a decision on training, a status, a potential optimization point, or the like, and any combination. As an example, the notification may include a suggestion that additional data for training may increase performance of the tracker model.

At S640, feedback on the trained tracker model is received. The feedback may include, without limitation, a decision on the training completion, a threshold setting, and the like, and any combination thereof. The feedback may be received from a user via the user terminal. It should be noted that the performance information is utilized for such feedback. In an example embodiment, a first threshold setting selected based on the PR curve is received as part of the feedback.

In some implementations, the feedback may be automatically generated and implemented within the tracker generator based on, for example, the performances, one or more policies, and the like. For example, an optimized threshold setting with respect to precision and recall may be determined using, for example, the PR curve. In another example, a decision to stop training may be made upon detecting a precision percentage of 85%, which is greater than a predefined precision threshold. Here, the precision threshold may be predefined by a user of the tracker model and set as part of one or more policies. Such automatically generated feedback may be presented to a user as, for example, suggestions in the generated notification.

At S650, it is checked whether the training is complete, and the tracker model is ready to use. If so, the operation continues with S660; otherwise, the operation continues with S655. Such completion may be based on the received feedback, automatically generated feedback, performance metrics, user policies, and the like, and more. As an example, the user feedback on the performance metric may suggest unsatisfactory performance of the current training state of the tracker model. In another example, the precision percentage of the combined performance metric may be below a minimum predefined precision threshold value.

At S655, a new testing set is generated. Upon determining that training is incomplete, the new testing set including unseen sample sentences with tracker relevant labels are generated. In an example embodiment, the sample sentences are selected from the index, the corpus, and the like, and are provided to the user for labeling. The operation returns to S610 to train and test the tracker model using the new testing set and to perform steps S610 through S650 until the training is determined to be complete at S650.

At S660, optionally, the trained tracker model is tuned based on the received feedback. In an example embodiment, upon receiving feedback to modify a classification threshold setting, the modification is implemented to tune the trained tracker model accordingly. The tuning of the tracker model is readily implemented to facilitate customization of the trained tracker model without repeated training and/or recreation of the tracker model. As an example, the tuning is immediately performed with feedback and an indication of complete training. It should be appreciated that such tuning is enabled by the performance metrics, combined performance metrics, and the like that provide quantitative visibility of the trained tracker model.

At S670, the trained tracker model is activated. The activated trained tracker model is deployed for the identification of trackers (or concepts) in future textual data. The future textual data are text records, such as transcripts of, for example, but not limited to, calls, emails, text messages (e.g., Slack® messages, Short Message System (SMS) messages, etc.), and the like, and more, that are collected in the natural human language. It should be noted that the trained tracker model is a customized trained tracker model according to the determined model performance.

It should be noted that monitoring the performance of the tracker model provides visibility on the reliability of the tracker model before deploying in live settings. To this end, unreliable classifications and/or identifications are avoided. The trained tracker model may be applied with confidence and accuracy, thereby reducing further training and/or generating of the tracker model. Moreover, such performances provide quantitative training statuses that allow objective decision-making on the training.

According to the disclosed embodiments, the performance of the trained tracker model may be determined after activation and deployment of the tracker model. A validation group of labeled sentences is input to the deployed tracker model for evaluating and determining the performance of the deployed tracker model. The validation group includes a small number of labeled sentences that may be unseen by the deployed tracker model. As an example, the validation group includes a similar number of labeled sentences to that of an equal-sized held-out group described in FIG. 7. The testing of the deployed tracker model is performed without additional training thereof. In an embodiment, the determined performance includes performance metrics such as, but not limited to, an accuracy, a precision, a recall, a PR curve, and the like, and any combination thereof. In an example embodiment, combined performance metrics may be determined from multiple validation groups. In a further example embodiment, S630 through S670 may be performed based on the monitored performances.

FIG. 7 is an example flowchart S610 for training and testing a tracker model using a testing set according to an embodiment. The method disclosed herein is performed at the tracker generator 110, FIG. 1 via components of the example framework 200, FIG. 2. FIG. 7 describes a training round using one testing set (i.e., one learning set) on a trained tracker model which validates the trained tracker model.

At S710, the testing set is ingested. The testing set is a labeling set that includes sample sentences that are labeled with respect to relevance to the respective tracker. The testing set includes sample sentences that are unseen by the tracker model. In an embodiment, the testing set is generated from new textual data. In another embodiment, the testing set is generated from the index (e.g., the index 310, FIG. 3). The sample sentences of the testing set are indexed and represented as vector sentence embeddings. In an example embodiment, the testing set may be selected to have variation yet still within the general scope of the input query's sentence (or tracker) for identification.

At S720, the textual data of the testing set are divided into distinct or disjoint groups. The textual data are randomly distributed in substantially equal-sized groups. Each equal-sized group of the plurality of groups includes unique textual data that are different from other groups. As an example, the textual data is grouped into 10 equal-sized groups, each including 10% of the textual data in the testing set. In an embodiment, each group of the plurality of groups is set aside for testing (or validating) the trained tracker model.

At S730, the tracker model is trained with a first subset. The first subset of the testing set has all sentences of the testing set, excluding sentences in a first group of the plurality of equal-sized groups. That is, the first subset and the first group is a pair that, when combined, result in the whole testing set. Following the example above, the first subset includes 90% of the textual data in the testing set, except the 10% that was grouped and set aside (or held-out).

At S740, a performance metric is determined from training with the first subset. The trained tracker model is tested with the remaining sentences in the first group of the testing set. Applying the trained tracked model to the sentences, outputs classification of the tested sentences according to tracker concept relevance. For example, the sentences may be labeled as related, unrelated, somehow related, or the like. The output of the test is compared to the known labels of the tested sentences in order to determine the performance metric such as, but not limited to, an accuracy, a precision, a recall, and the like, and any combination thereof of the first subset-round of training. The precision is a proportion of correct detection out of all detections by the tracker model and defined as a number of true positives over a total number of detections. A recall (or hit rate) is defined as a number of correct detections out of a total number of true positives existing in the tested first group. That is, the recall indicates how many (or proportion) of correct sentences are actually detected from all existing correct sentences. Such performance metrics may be represented as, for example, but not limited to, percentage, fraction, proportion, scale, and the like, and any combination thereof.

At S750, it is checked whether all of the plurality of groups are tested. If so, the operation terminates; otherwise, the operation continues with S730 using a second subset and a second group of the testing set.

The second subset includes sentences of the testing set that are not part of the second group. It should be noted that the second group has different sentences from the first group. The repeated training and determining the performance metric may be referred to as the second subset round of training. The subset training may be repeated for the number of the groups in the plurality of groups generated in S720. Upon termination, the operation continues with S620, FIG. 6 to provide the plurality of performance metrics determined for the plurality of subsets and their subset rounds of training the tracker model.

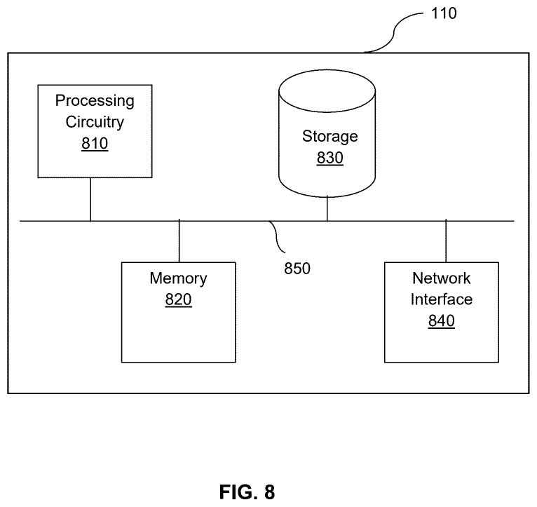

FIG. 8 is an example schematic diagram of the tracker generator 110 according to an embodiment. The tracker generator 110 includes a processing circuitry 810 coupled to a memory 820, a storage 830, and a network interface 840. In an embodiment, the components of the tracker generator 110 may be communicatively connected via a bus 850.

The processing circuitry 810 may be realized as one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read-only memory, flash memory, etc.), or a combination thereof.

In one configuration, software for implementing one or more embodiments disclosed herein may be stored in storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read-only memory (CD-ROM), Digital Versatile Disks (DVDs), or any other medium which can be used to store the desired information.

The network interface 840 allows the tracker generator 110 to communicate with other elements over the network 150 for the purpose of, for example, receiving data, sending data, and the like.

It should be understood that the embodiments described herein are not limited to the specific architecture illustrated in FIG. 8, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof.

Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for monitoring performance of a tracker model, comprising:
validating a tracker model using a testing set that includes a plurality of labeled textual data, wherein validating generates a trained tracker model and at least one set of performance metrics;
generating a combined performance metric by aggregating the at least one set of performance metrics; and
causing generation of a notification, wherein the notification includes the generated combined performance metric.

2. The method of claim 1, further comprising:
receiving feedback on the trained tracker model based on the combined performance metric.

3. The method of claim 1, further comprising:
determining, based on the combined performance metric, that the trained tracker model training is complete; and
activating the trained tracker model for an identification of future textual data.

4. The method of claim 1, further comprising:
determining, based on the combined performance metric, that the trained tracker model training is incomplete;
generating a new testing set that has a plurality of new labeled textual data; and
repeating the validating, generating, and causing.

5. The method of claim 2, wherein the feedback has a threshold setting of the trained tracker model, wherein the threshold setting is identified from the combined performance metric of the trained tracker model, further comprising:
tuning the trained tracker model according to the threshold setting.

6. The method of claim 1, wherein validating the tracker model further comprises:
dividing the plurality of labeled textual data of the testing set into substantially equal-sized groups;
training the tracker model with a first subset to obtain a first trained tracker model;
wherein the first subset is a portion of the plurality of labeled textual data apart from a first equal-sized group;
applying the first trained tracker model to textual data of the first equal-sized group in order to label tracker-relevant labels for the textual data of the first equal-sized group; and
determining the set of performance metrics based on the labeled textual data of the first equal-sized group.

7. The method of claim 6, further comprising:
successively repeating the validating of the tracker model using all of the substantially equal-sized groups.

8. The method of claim 1, wherein the set of performance metrics and the combined performance metric include any one of: an accuracy, a precision, a recall, and a precision-recall curve.

9. The method of claim 1, wherein the trained tracker model is configured to identify a unique concept in textual data, wherein the textual data is derived from at least one of: email, text message, and call.

10. A non-transitory computer readable medium having stored thereon instructions for causing a processing circuitry to execute a process for live migration of an index in a document store, the process comprising:
validating a tracker model using a testing set that includes a plurality of labeled textual data, wherein validating generates a trained tracker model and at least one set of performance metrics;
generating a combined performance metric by aggregating the at least one set of performance metrics; and
causing generation of a notification, wherein the notification includes the generated combined performance metric.

11. A system for monitoring performance of a tracker model, comprising:
a processing circuitry; and
a memory, the memory containing instructions that, when executed by the processing circuitry, configure the system to:
validate a tracker model using a testing set that includes a plurality of labeled textual data, wherein validating generates a trained tracker model and at least one set of performance metrics;
generate a combined performance metric by aggregating the at least one set of performance metrics; and
cause generation of a notification, wherein the notification includes the generated combined performance metric.

12. The system of claim 11, wherein the system is further configured to:
receive feedback on the trained tracker model based on the combined performance metric.

13. The system of claim 11, wherein the system is further configured to:
determine, based on the combined performance metric, that the trained tracker model training is complete; and
activate the trained tracker model for an identification of future textual data.

14. The system of claim 11, wherein the system is further configured to:
determine, based on the combined performance metric, that the trained tracker model training is incomplete;
generate a new testing set that has a plurality of new labeled textual data; and
repeat the validating, generating, and causing.

15. The system of claim 12, wherein the feedback has a threshold setting of the trained tracker model, wherein the threshold setting is identified from the combined performance metric of the trained tracker model, wherein the system is further configured to:
tune the trained tracker model according to the threshold setting.

16. The system of claim 11, wherein the system is further configured to:
divide the plurality of labeled textual data of the testing set into substantially equal-sized groups;
train the tracker model with a first subset to obtain a first trained tracker model;
wherein the first subset is a portion of the plurality of labeled textual data apart from a first equal-sized group;
apply the first trained tracker model to textual data of the first equal-sized group in order to label tracker-relevant labels for the textual data of the first equal-sized group; and
determine the set of performance metrics based on the labeled textual data of the first equal-sized group.

17. The system of claim 16, wherein the system is further configured to:
successively repeat the validating of the tracker model using all of the substantially equal-sized groups.

18. The system of claim 11, wherein the set of performance metrics and the combined performance metric include any one of: an accuracy, a precision, a recall, and a precision-recall curve.

19. The system of claim 11, wherein the trained tracker model is configured to identify a unique concept in textual data, wherein the textual data is derived from at least one of: email, text message, and call.
